(19) United States
(12) Patent Application Publication
(10) Pub. No.: US 2026/0031439 A1
(43) Pub. Date: Jan. 29, 2026

(54) SHORT-CUT CARBON FIBER COMPOSITE-HIGH STRENGTH STEEL HYBRID BIONIC STRUCTURE BATTERY BOX AND ITS INTEGRATED FORMING METHOD

(71) Applicant: Jilin University, Changchun City (CN)

(72) Inventors: Dengfeng WANG, Changchun City (CN); Jialin DONG, Changchun City (CN); Wenchao XU, Changchun City (CN); Hao SUN, Changchun City (CN); Fengmin LIAN, Changchun City (CN)

(73) Assignee: Jilin University, Changchun City (CN)

(21) Appl. No.: 19/276,498

(22) Filed: Jul. 22, 2025

(30) Foreign Application Priority Data
Jul. 23, 2024 (CN) 202410988236.4

(51) Int. Cl. H01M 50/117

(52) U.S. Cl. CPC H01M 50/117; H01M 2220/20

(57) ABSTRACT

Provided are a short-cut carbon fiber composite (SCFC)-high strength steel (HSS) hybrid bionic structure battery box and its integrated forming method. A SCFC-HSS hybrid bionic structure lower box body includes a lower box framework made of high strength steel and a SCFC lower box matrix; and an upper box body and the lower box are connected by bolts to form a complete SCFC-HSS hybrid bionic structure battery box. A high strength steel lower box framework scheme is designed based on the principle of bionics, then welding and surface treatment are carried out to obtain a bionic lower box framework structure, and the bionic lower box framework structure is placed in a mold for integrated injection molding using a SCFC matrix material.

### CROSS-REFERENCE TO RELATED APPLICATION

This patent application claims the benefit and priority of Chinese Patent Application No. 202410988236.4 filed with the China National Intellectual Property Administration on Jul. 23, 2024, the disclosure of which is incorporated by reference herein in its entirety as part of the present application.

### TECHNICAL FIELD

The present disclosure belongs to the technical field of lightweight design and fabrication of battery boxes of electric automobiles, and in particular to a short-cut carbon fiber composite-high strength steel hybrid bionic structure battery box and its integrated forming method.

### BACKGROUND

The automobile industry, as a pillar industry of the national economy, has effectively boosted economic growth. To solve the problem of serious environmental pollution caused by conventional internal combustion engine vehicles, new energy vehicles have become a key development direction of transformation and upgrading of the automobile industry. To meet the needs of electric vehicles with sufficient cruising range, a larger battery box is needed. Therefore, compared with the conventional fuel vehicles, the overall mass of battery electric vehicles is increased by 15%-40%, which has adverse effects on power consumption, cruising range, power, passive safety, braking and durability of the vehicles. Therefore, the battery electric vehicles exhibit more urgent demands for lightweight technologies. The battery box, as an important component of the electric automobile, accounts for about ⅕ of the mass of a power battery system, so reducing the mass of battery box plays an important role in improving the performance of the whole vehicle. In the prior art, the material of the battery box is mainly selected from one of high strength steel, aluminum alloy and continuous carbon fiber composite. A steel battery box is heavy in weight and low in cost, and is mainly used for economical vehicles, and the aluminum alloy and continuous carbon fiber composite battery box are light in weight and high in cost, and are often used in middle and high-end electric vehicles. The foregoing battery boxes all have their own advantages and disadvantages, and their application scopes are limited. So far, there is no similar technical solution of a hybrid battery box that integrates high strength steel with lowcost short-cut carbon fiber composite, as provided in the present disclosure. Therefore, it is necessary to develop a lowcost, high-performance and lightweight hybrid battery box with short-cut carbon fiber composite-high strength steel to solve the problem of bionic hollow-out lightweight design of the high strength steel framework of the lower box of the battery box and master the core technology for controlling the interlocking strength at the structure interface between the high strength steel framework and the short-cut carbon fiber composite during the forming of a bulky hybrid battery box, thereby making the battery box meet the safety test requirements of vibration, mechanical impact, simulated collision and extrusion stipulated by the Chinese standard GB38031-2020. The important technical requirements of the electric vehicles for the application of the lowcost, high-performance and lightweight battery box are satisfied.

At present, there are some different schemes about lightweight research and development of a composite battery box for an electric vehicle in China. For example, in Chinese invention patent No. 202223003047.2, a composite housing of a battery box for an electric vehicle is provided. An integrally molded long glass fiber reinforced epoxy resin structure is adopted, which can effectively increase the integrity of a housing of a battery pack and achieve lightweight. However, the long glass fiber reinforced epoxy resin composite battery box is poor in impact resistance, and its molding process is relatively complicated, making it difficult to meet the performance test requirements of the battery box. In China invention patent No. 2020103806265, an aluminum alloy-continuous fiber reinforced composite hybrid battery box and a fabrication method thereof ate provided. The aluminum alloy material is welded and glued to fabricate a hollow component, and then a fiber reinforced layer is laid on the surface of the aluminum alloy hollow component to enhance the strength and stiffness of the part and achieve the purpose of the lightweight structure. The shortcomings of this scheme are that the fabrication process of the aluminum alloy-continuous fiber reinforced composite hybrid parts is complex, high in raw material and fabricate costs, long fabrication cycle and low efficiency. In Chinese invention patent No. 202110960677.X, a lightweight puncture-proof composite battery box housing is provided, which is composed of a glass fiber composite skin, Kevlar fiber puncture-proof sandwich, a carbon fiber checkered fabric structure layer and a hard foam collision-proof sandwich, and is added with a carbon fiber framework, thereby having good puncture-proof and impact-resistant characteristics. The shortcomings of this scheme are that there are many types of fibers selected, the cost of raw materials is high, the fabrication process of compounding heterogeneous materials and adding carbon fiber framework is complicated, and the fabrication difficulty is high.

Therefore, it is an urgent key technical problem to develop a battery box with simple fabrication process, less types of materials, light weight, high strength and impact resistance, and a fabrication method for the battery box.

### SUMMARY

Some embodiments disclose a short-cut carbon fiber composite (SCFC)-high strength steel (HSS) hybrid bionic structure battery box, which has an objective of developing a SCFC-HSS hybrid bionic structure battery box with high performance, low cost and light weight by combining the advantages of high strength, high modulus and low cost of high strength steel and features of low weight, low cost and injection molding of SCFC made of carbon fiber off-cuts, thereby satisfying the needs of economical electric vehicles. A high strength steel bionic lower box framework is embedded in a lower box of the battery box to improve the collision, impact and extrusion resistance of the battery box, reinforce of a SCFC base structure of the lower box of the battery box, thereby satisfying the performance requirements of battery box. An upper box body of the battery box has low requirements on mechanical properties, mainly plays a role in sealing, and can be directly injection-molded using a light material SCFC.

On the premise of ensuring the mechanical properties of the battery box, a SCFC-HSS hybrid bionic structure battery box which takes into account the raw material and processing costs and requirements of performance and lightweight is designed, the structural characteristics of leaf veins and tortoiseshells are selected as the inspiration of bionic design, thereby designing a hollow-out framework of a lightweight high strength steel bionic lower box, then, off-cuts on a carbon fiber product production line are cut into short fiber and mixed with engineering plastics to prepare SCFC particles and to achieve low cost. Afterwards, the hollow-out framework and the SCFC particles undergo integrated injection molding to fabricate a SCFC-HSS hybrid bionic structure lower box body of the battery box.

Specifically, the present disclosure provides a short-cut carbon fiber composite (SCFC)-high strength steel (HSS) hybrid bionic structure battery box, wherein the bionic structure battery box comprises a bionic structure lower box body made of the hybrid of SCFC and HSS, and a SCFC upper box body, and the SCFC upper box body is connected with the bionic structure lower box body by connecting bolts.

Further, the bionic structure lower box body comprises a bionic lower box framework made of HSS and a SCFC base structure, which are integrated by injection molding.

Taking the characteristics of leaf veins or a tortoiseshell bearing structure as a reference, based on a structural size of the battery box, and the performance requirements of bearing a battery module and resisting external impact and extrusion, a hollow-out framework structure scheme of the high strength steel bionic lower box is designed according to the distribution characteristics of bearing ribs of the leaf and the tortoiseshell.

Further, the bionic lower box framework comprises high strength steel bionic primary ribs arranged perpendicular to each other at a middle of a floor of the bionic structure lower box body along longitudinal and transverse directions, and high strength steel bionic secondary stiffeners spaced apart along both sides of one of the high strength steel bionic primary ribs arranged along the longitudinal direction, the high strength steel bionic primary ribs and the high strength steel bionic secondary stiffeners extend to upper frames of side vertical plates; local spaces surrounded by the high strength steel bionic primary ribs and the high strength steel bionic secondary stiffeners are provided in a tortoiseshell-like pattern to jointly form the bionic lower box framework; each of four side edges at a bottom of the bionic lower box framework is provided with an L-shaped high strength steel right-angled lower frame, and an inverted L-shaped high strength steel right-angled upper frame at a top of the bionic lower box framework is aligned with a vertical edge of the lower frame, and a top surface of the inverted L-shaped high strength steel right-angled upper frame extends horizontally outward to be screwed with the SCFC upper box body; and the high strength steel bionic primary ribs, the high strength steel bionic secondary stiffeners, the upper frame and the lower frame of the bionic structure lower box body are connected by welding to ensure that the structure on each surface of the framework is smooth, so that the framework can be tightly bound with the SCFC matrix during integrated injection molding conveniently to improve the connection strength, and the hollow-out framework structure of the high strength steel bionic lower box body is obtained.

Further, the short-cut carbon fibers are made by cutting the T300-T700 carbon fiber off-cuts recovered from a carbon fiber product production line; a composite matrix of the SCFC employs one of engineering plastics selected from PA (polyamide), PP (polypropylene), PE (polyethylene) and PPS (polyphenylene sulfide), the mass of the short-cut carbon fiber accounts for 20%-60% of the mass of the SCFC, and SCFC particles are made by a compounding extrusion process of the composite matrix and the short-cut carbon fiber for injection molding of the battery box.

The present disclosure further provides an integrated forming method of the SCFC-HSS hybrid bionic structure battery box, including the following steps:
step 1: selecting a high strength steel plate with a tensile strength of 500 MPa to 1300 MPa and a thickness of 1 mm to 6 mm, cutting the high strength steel plate into the high strength steel bionic primary ribs, the high strength steel bionic secondary stiffeners, an upper frame plate and a lower frame plate, bending the upper frame plate and the lower frame plate into a right-angled upper frame and a right-angled lower frame, respectively, and machining according to size requirements of the high strength steel bionic primary ribs, the high strength steel bionic secondary stiffeners, the right-angle upper frame and the right-angle lower frame, and welding the high strength steel bionic primary ribs, the high strength steel bionic secondary stiffeners, the right-angle lower frame and the right-angle upper frame into the bionic hollow-out lower box framework by laser;
step 2: roughening surfaces of the bionic lower box framework with 10 W-100 W power laser, or immersing the bionic lower box framework in an inorganic acid or organic acid solution for 10 min-30 min for chemical corrosion to increase surface roughness and surface area, thereby improving bonding performance between the bionic lower box framework and the SCFC during injection molding;
step 3: coating a release agent on a surface of a lower box forming mold, putting the bionic lower box framework prepared into the lower box forming mold and fixing the bionic structure lower box body, keeping a specified gap between the bionic lower box framework and the lower box forming mold within 1 mm-10 mm after mold clamping, and injecting prepared SCFC particles into a cavity of the lower box forming mold by an injection molding machine for integrated forming; and
step 4: after the SCFC is cured for 30-180 min, opening and demolding the lower box forming mold to obtain the bionic structure lower box body.

Compared with the prior art, the SCFC-HSS hybrid bionic structure battery box provided by some embodiments combines the characteristics of high strength, high modulus and low cost of high strength steel and the technological advantages of light weight, low cost and injection molding of the SCFC, and overcomes the shortcomings of heavy weight and low lightweight level of a high strength steel battery box, as well as high cost and complex fabrication process of an aluminum alloy and continuous carbon fiber composite battery box. According to the SCFC-HSS hybrid bionic structure battery box and the integrated forming method thereof provided by some embodiments, the problem of bionic hollow-out lightweight design of the high strength steel framework of the lower box of the battery box is solved, the core technology for controlling the interlocking strength at the structure interface between the high strength steel framework and the SCFC during the forming of a large and complex hybrid battery box is mastered. Lightweight, low cost and high performance of the battery box are implemented. The characteristics of simple molding process and high efficiency are achieved. The high strength steel bionic framework in the SCFC-HSS hybrid bionic structure lower box body remains the lowcost and high-performance characteristics of the high strength steel battery box, can meet the harsh test conditions such as external collision, impact and extrusion, and can effectively achieve a lightweight structure due to the hollow-out design of the high strength steel bionic framework of the lower box and the low density of the SCFC matrix material. Moreover, the SCFC upper box body can ensure the sealing requirements of the battery box, and can achieve lightweight performance. Therefore, the SCFC-HSS hybrid bionic structure battery box can satisfy the needs of economical electric vehicles better, and has wide application prospects.

### BRIEF DESCRIPTION OF THE DRAWINGS

FIG. 1A and FIG. 1B are diagrams of a SCFC-HSS hybrid bionic structure battery box, according to an embodiment of the present invention.

FIG. 2A, FIG. 2B and FIG. 2C are diagrams of a SCFC-HSS hybrid bionic structure lower box body, according to an embodiment of the present invention.

FIG. 3A, FIG. 3B and FIG. 3C are diagrams of integrated molding of a SCFC-HSS hybrid bionic structure lower box body, according to an embodiment of the present invention.

FIG. 4 is a diagram of a SCFC upper box body, according to an embodiment of the present invention.

### DETAILED DESCRIPTION OF THE EMBODIMENTS

To describe the embodiments of the present disclosure more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

The technical solutions of the present disclosure are further described below with reference to accompanying drawings and embodiments.

It should be appreciated that in the drawings: 1 bionic structure lower box body made of a hybrid of SCFC and HSS; 2 SCFC upper box body; 3 connecting bolt; 101 bionic lower box framework; 102 SCFC base structure; 103 upper mold; 104 lower mold.

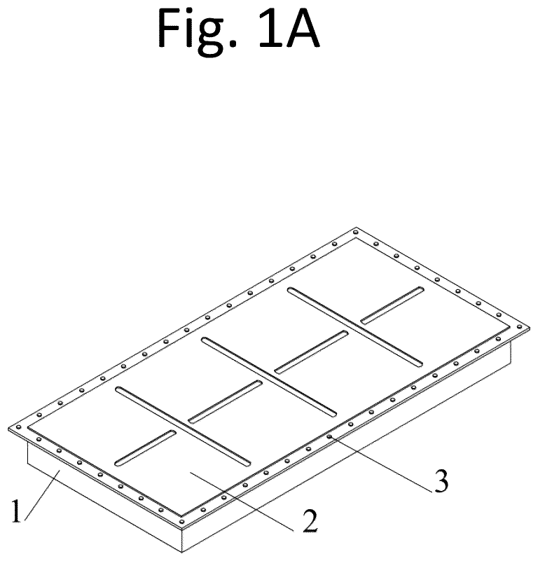

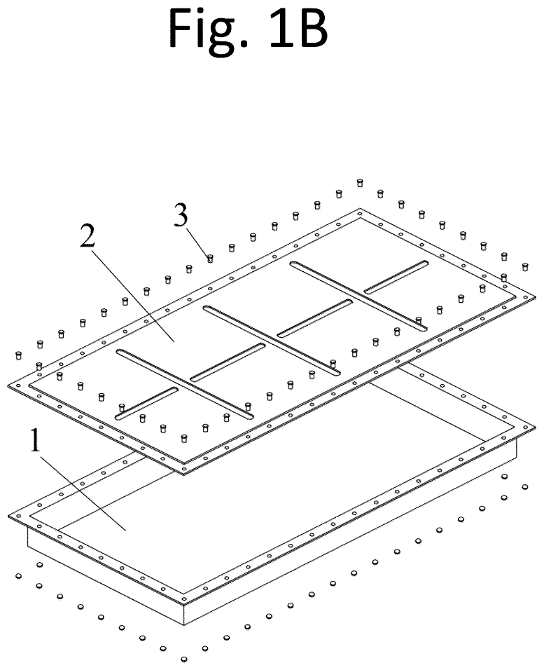

As shown in FIG. 1, the present disclosure provides a short-cut carbon fiber composite (SCFC)-high strength steel (HSS) hybrid bionic structure battery box, where the overall battery box is as shown in FIG. 1A, including a SCFC-HSS hybrid bionic structure lower box body 1, a SCFC upper box body 2, and connecting bolt 3. The lower box 1 and the upper box body 2 are connected and assembled by the connecting bolts 3, as shown in FIG. 1B, thereby forming a complete SCFC-HSS hybrid bionic structure battery box.

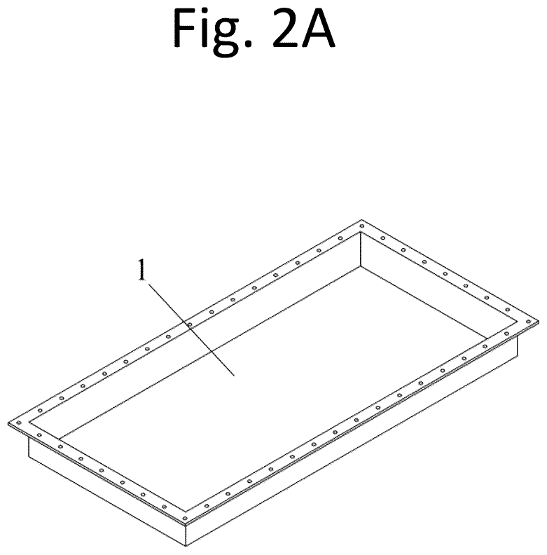

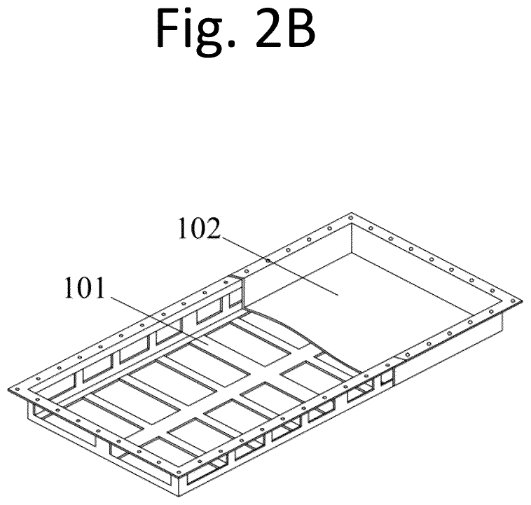

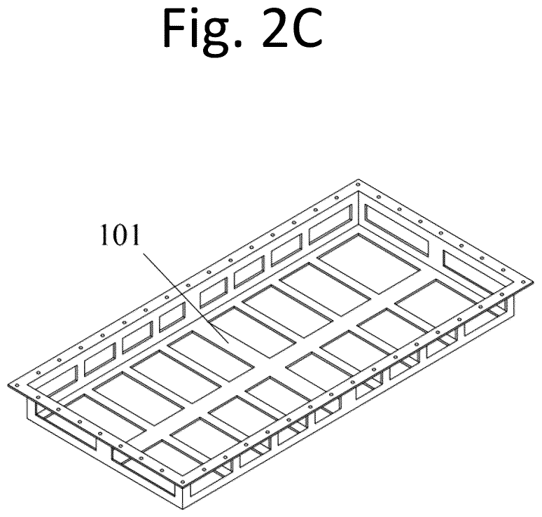

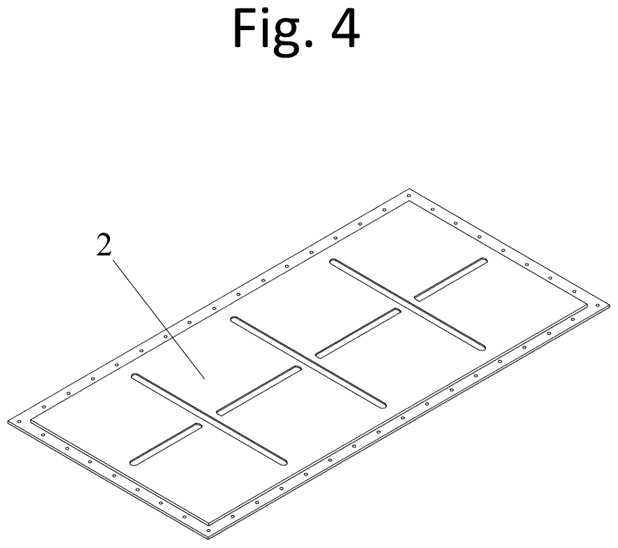

FIG. 2A shows the SCFC-HSS hybrid bionic structure lower box body 1, which is integrally molded with a bionic lower box framework 101 made of HSS in FIG. 2B and a SCFC base structure 102 by mold injection. The SCFC base structure 102 is coated on an outer surface of the bionic lower box framework 101 made of high strength steel. The SCFC base structure 102 and the bionic lower box framework 101 are integrated into a whole, that is, an overall structure of the SCFC-HSS hybrid bionic structure lower box body 1 of the battery box. After the lower box is screwed with the SCFC upper box body 2 fabricated by SCFC injection molding shown in FIG. 4, a complete battery box meeting various performance indexes and lightweight requirements is obtained.

The bionic lower box framework 101 made of the high strength steel is shown in FIG. 2C, and the structural features of plant and animal bearing structures such as leaf veins and tortoiseshells are extracted by bionics principle as reference. According to the structural size and the performance requirements of bearing a battery module and resisting external collision, impact and extrusion loads, the framework structure scheme is designed according to the distribution characteristics of bearing ribs of the leaves and tortoiseshells as shown in FIG. 2C. The bionic lower box framework 101 made of the high strength steel is fabricated by cutting, machining and welding a high strength steel plate with a thickness of 1 mm-6 mm and a tensile strength of 500 MPa-1300 MPa, and a structure thereof includes high strength steel bionic primary ribs arranged perpendicular to each other along longitudinal and transverse directions of a floor of the lower box, and high strength steel bionic secondary stiffeners spaced apart along both sides of the longitudinal primary rib, both of which extend to upper frames of side vertical plates. An arrangement mode of the ribs and the stiffeners are designed based on bionics and corresponds to a bionic structure of ribs distribution of the leaf veins and the tortoiseshell. Local spaces surrounded by the transverse and longitudinal stiffeners and ribs are arranged in a tortoiseshell-like pattern to jointly form the bionic lower box framework. Each of four side edges at the bottom of the box are provided with an L-shaped high strength steel right-angled lower frame, and an inverted L-shaped high strength steel right-angled upper frame at the top of the box is aligned with a vertical edge of the lower frame, and a top surface of the inverted L-shaped high strength steel right-angled upper frame extends horizontally outward to be screwed with the upper box body. The ribs, the stiffeners and the frames of the lower box are connected by welding to ensure that the structure on each surface of the framework is smooth, making the connection strength between the framework and the SCFC matrix during the integrated injection molding improved.

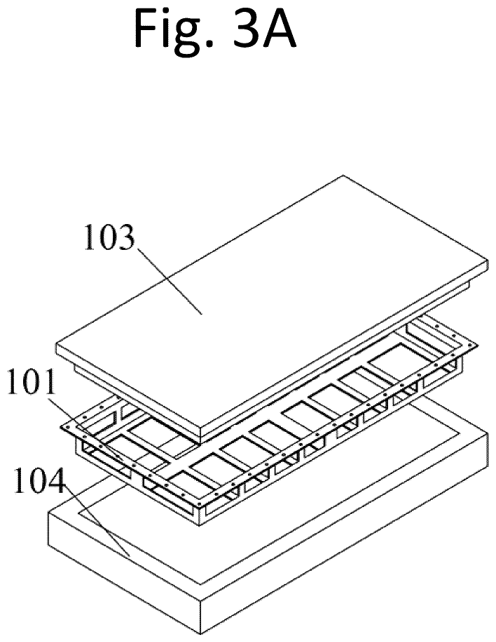

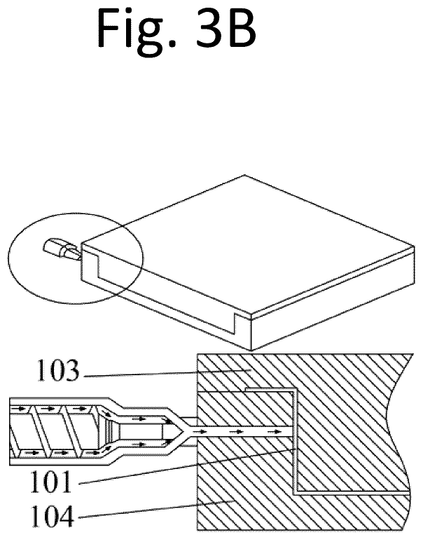

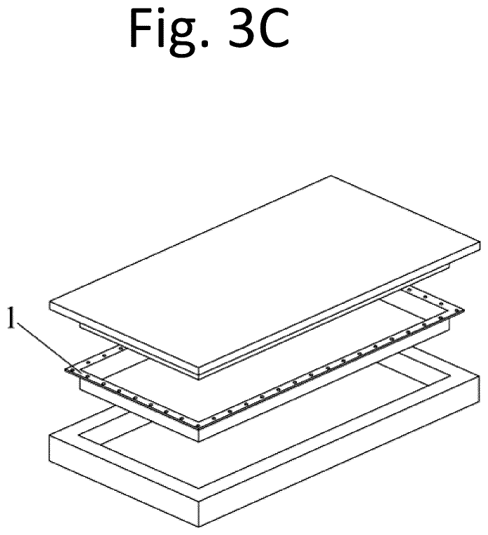

FIG. 3 shows an integrated molding process of a SCFC-HSS hybrid bionic structure lower box body. The bionic lower box framework 101 made of HSS after welding and laser surface treatment is as shown in FIG. 3A and is placed and fixed in a lower mold 104 for molding, and after mold clamping, a specified gap is maintained between the framework and the mold to form an injection molding cavity. The integrated injection molding of the lower box body of the battery box is as shown in FIG. 3B, injection molding particles are short-cut carbon fibers cut from T300-T700 carbon fiber off-cuts recovered from a carbon fiber product production line, a composite matrix employs one of engineering plastics selected from PA, PP, PE, and PPS, the mass of the short-cut carbon fiber accounts for 20%-60% of the mass of SCFC, and SCFC particles are made by a compounding extrusion process. The cavity between the mold and the framework is filled with the SCFC matrix by injection molding, as shown in FIG. 3B. After curing and molding, the mold is opened to obtain the SCFC-HSS hybrid bionic structure lower box body. An upper box body of the battery box can be fabricated by direct injection molding of SCFC with an upper box mold, as shown in FIG. 4. The upper box body and the lower box body are connected by the connecting bolts to fabricate the SCFC-HSS hybrid bionic structure battery box.

The integrated forming method of the SCFC-HSS hybrid bionic structure battery box disclosed by some embodiments has the advantages of combining the characteristics of high strength, high modulus and low cost of the high strength steel with the technological advantages of lightweight, low cost and injection molding of SCFC. The shortcomings of heavy weight and low lightweight level of a high strength steel battery box, as well as high cost and complex fabrication process of an aluminum alloy and continuous carbon fiber composite battery box are overcome. The lightweight and high performance of the SCFC-HSS battery box is implemented, and the characteristics of simple molding process, high efficiency and low cost are achieved. The bionic framework made of the high strength steel in the SCFC-HSS hybrid bionic structure lower box body remains the low cost and high-performance characteristics of the high strength steel battery box, can meet the harsh test conditions such as external collision, impact and extrusion, and can effectively achieve a lightweight structure due to the hollow-out design of the high strength steel bionic framework of the lower box and the low density of the SCFC matrix material. Moreover, the SCFC upper box body can ensure the sealing requirements of the battery box, and can achieve lightweight performance. Therefore, the SCFC-HSS hybrid bionic structure battery box can satisfy the needs of economical electric vehicles better, and has wide application prospects.

The foregoing embodiments have only expressed several implementations of the present disclosure, which are described in a more specific and detailed way, but are not therefore to be construed as limiting the scope of the present disclosure. It should be noted that variations and modifications may be made by those of ordinary skill in the art without departing from the spirit of the present disclosure, all of which fall within the scope of the present disclosure.

What is claimed is:

1. A short-cut carbon fiber composite (SCFC)-high strength steel (HSS) hybrid bionic structure battery box, comprising:
a bionic structure lower box body made of the hybrid of SCFC and HSS, and a SCFC upper box body, wherein
the SCFC upper box body is connected with the bionic structure lower box body by connecting bolts.

2. The bionic structure battery box according to claim 1, wherein the bionic structure lower box body comprises a bionic lower box framework made of HSS and a SCFC base structure, which are integrated by injection molding.

3. The bionic structure battery box according to claim 2, wherein the bionic lower box framework comprises
high strength steel bionic primary ribs arranged perpendicular to each other at a middle of a floor of the bionic structure lower box body along longitudinal and transverse directions, and high strength steel bionic secondary stiffeners spaced apart along both sides of one of the high strength steel bionic primary ribs arranged along the longitudinal direction, wherein
the high strength steel bionic primary ribs and the high strength steel bionic secondary stiffeners extend to upper frames of side vertical plates;
local spaces surrounded by the high strength steel bionic primary ribs and the high strength steel bionic secondary stiffeners are provided in a tortoiseshell-like pattern to jointly form the bionic lower box framework;
each of four side edges at a bottom of the bionic lower box framework is provided with an L-shaped high strength steel right-angled lower frame, an inverted L-shaped high strength steel right-angled upper frame at a top of the bionic lower box framework is aligned with a vertical edge of the lower frame, and a top surface of the inverted L-shaped high strength steel right-angled upper frame extends horizontally outward to be screwed with the SCFC upper box body; and
the high strength steel bionic primary ribs, the high strength steel bionic secondary stiffeners, the upper frame and the lower frame of the bionic structure lower box body are connected by welding.

4. The bionic structure battery box according to claim 2, wherein the short-cut carbon fiber of the SCFC is cut from T300-T700 carbon fiber off-cuts recovered from a carbon fiber product production line; and
a composite matrix of the SCFC employs one of engineering plastics selected from PA (polyamide), PP (polypropylene), PE (polyethylene) and PPS (polyphenylene sulfide), a mass of the short-cut carbon fiber accounts for 20%-60% of a mass of the SCFC, and SCFC particles are made by a compounding extrusion process of the composite matrix and the short-cut carbon fiber.

5. An integrated forming method of the bionic structure battery box, comprising:
selecting a high strength steel plate with a tensile strength of 500 MPa to 1300 MPa and a thickness of 1 mm to 6 mm,
cutting the high strength steel plate into the high strength steel bionic primary ribs, the high strength steel bionic secondary stiffeners, an upper frame plate and a lower frame plate,
bending the upper frame plate and the lower frame plate into a right-angled upper frame and a right-angled lower frame, respectively, and
welding the high strength steel bionic primary ribs, the high strength steel bionic secondary stiffeners, the right-angled upper frame and the right-angled lower frame into the bionic lower box framework by laser;
roughening surfaces of the bionic lower box framework with 10 W-100 W power laser, or immersing the bionic lower box framework in an inorganic acid or organic acid solution for 10 min-30 min for chemical corrosion to increase surface roughness and surface area, thereby improving bonding performance between the bionic lower box framework and the SCFC during injection molding;
coating a release agent on a surface of a lower box forming mold, wherein the coating the release agent comprises
placing the bionic lower box framework prepared into the lower box forming mold and fixing the bionic structure lower box body,
keeping a specified gap between the bionic lower box framework and the lower box forming mold within 1 mm-10 mm after mold clamping, and
injecting prepared SCFC particles into a cavity of the lower box forming mold by an injection molding machine for integrated forming; and
after the SCFC is cured for 30-180 min, opening and demolding the lower box forming mold to obtain the bionic structure lower box body.
